(19) United States
(12) Patent Application Publication
(10) Pub. No.: US 2004/0246677 A1
(43) Pub. Date: Dec. 9, 2004

(54) Computer cooling apparatus

(76) Inventor: Shih-Tsung Chen, Taipei (TW)

Correspondence Address: FENWICK & WEST LLP, SILICON VALLEY CENTER, 801 CALIFORNIA STREET, MOUNTAIN VIEW, CA, 94041, US

(21) Appl. No.: 10/803,807

(22) Filed: Mar. 17, 2004

(30) Foreign Application Priority Data
Mar. 17, 2003 (TW) 092204072

(51) Int. Cl. G06F 1/20

(52) U.S. Cl. 361/697; 361/687

(57) ABSTRACT

A cooling system for a computer transfers heat away from a power supply and/or a central processing unit (CPU) in the computer. In an embodiment, heat is drawn away from the CPU to a heat sink by way of a heat pipe and a base member. In another, the heat sink is installed parallel to a power supply unit within the computer, and a fan is installed between the power supply and the heat sink.

### CROSS REFERENCE TO RELATED APPLICATIONS

This application claims the right of priority based on Taiwanese application serial No. 092204072, filed Mar. 17, 2003, which is incorporated in its entirety by reference.

### BACKGROUND

1. Field of the Invention

This invention relates generally to cooling the interior of a computer chassis, and in particular to cooling a chassis with a fan and a heat sink.

2. Background of the Invention

Decreases in the size of integrated circuits and increases in their processing capabilities have highlighted the need for effective and efficient cooling systems in computers. Heat generated during the operation of a computer, if not properly dissipated, can damage or reduce the useful lifetime of integrated circuits and other electronic components. Circuits also tend to run more slowly and less efficiently when hot. The problem of overheating is particularly acute in the case of small form factor computers or other high performance computers housed in small chassis where hot air can easily be trapped within a confined space.

The main hotspots within a computer chassis tend to be near the central processing unit (CPU) and the power supply. A number of existing computer cooling systems deal with each heat source separately, in some cases relying on two fans to dissipate heat produced in different sections of the chassis. Such an arrangement can be very noisy during operation of the computer. In addition, mounting multiple fans within a limited space can exacerbate space issues within an already cramped chassis, particularly because the fan must be isolated from any cables or wires that could get caught in the fan's rotation.

Thus, what is needed is a computer cooling device that can effectively dissipate the heat generated by a computer CPU and a power supply.

### SUMMARY OF THE INVENTION

The present invention overcomes the shortcomings of the prior art by providing a computer cooling system that eliminates the need for a specialized CPU fan. In one embodiment of the invention, a cooling apparatus comprises a base member, a heat conductor, a heat sink, a fan, and a housing for the heat sink and fan. The base member may be installed over a CPU to carry away heat generated by the CPU. The heat of the base member may then be transferred to a heat conductor and to a heat sink. The fan disperses the heat transferred to the heat sink by directing an airflow through the heat sink and out a window in a computer chassis. In an embodiment, the airflow is directed over a power supply, thereby expelling heat generated by the power supply out of the computer.

In another embodiment, a circulation device is adapted to fit between a heat sink to which heat from a computer CPU can be transferred and a power supply for the computer. The circulation device can be installed adjacent and parallel to both the heat sink and the power supply, and direct heat away from the heat sink and power supply out through a window in a computer chassis.

FIGS. 1 and 2 depict prior art apparati for cooling the interior of a computer chassis. FIG. 1 includes a rotating fan A3 that can be mounted on top of a conductive grid A1. The grid A1 can be installed above a CPU (not shown), and secured with a fastener A2. Heat produced by the CPU is transferred to the fan A3 through the grid A1. FIG. 2 shows the top view of a cooling fan B1 that can be installed adjacent to a power supply (not shown), to discharge heat produced by the power supply when it is running.

The prior art combination of the apparati in FIGS. 1 and 2 has several disadvantages. Housing and operating two fans A3 B1 in a computer chassis produces load noise. In addition, the configuration of the fans may produce conflicting airflows, causing heat to circulate within the chassis rather than being efficiently exhausted. Finally, having two fans A3 B1, each of which must be consumes space and must be configured properly, complicates assembly.

Another embodiment includes a heat conductor that comprises a heat pipe containing a liquid and/or a mesh grid for facilitating heat transfer. In an embodiment, the apparatus is adapted for use in a small form factor computer.

### BRIEF DESCRIPTION OF THE DRAWINGS

FIG. 1 is an exploded view of a prior art heat sink and fan for use with a CPU.

FIG. 2 is a top view of a prior art fan for cooling a power supply.

FIG. 3 is an exploded view of a computer cooling apparatus and computer chassis in accordance with an embodiment of the invention.

FIG. 4 is a perspective view of a CPU cooler in accordance with an embodiment of the invention.

FIG. 5 is a perspective view of a computer chassis for use in accordance with an embodiment of the invention.

### DETAILED DESCRIPTION OF THE PREFERRED EMBODIMENTS

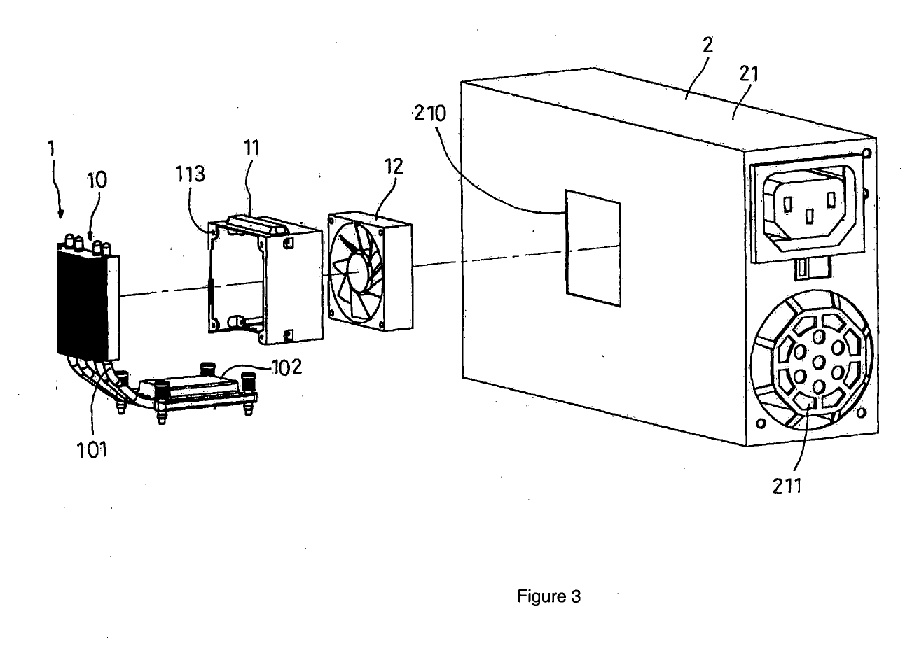

FIG. 3 is an exploded view of single fan computer cooling apparatus and computer chassis 2 in accordance with an embodiment of the invention. A CPU cooler 1 comprises a heat sink 10 thermally coupled to a base plate 102 via a heat conductor 101. The CPU cooler 1 can be installed in a housing 11 along with a circulating device 12. The heat conductor 101 of FIG. 3 comprises a set of four heat pipes 101 connected to the base member 102; however, in other embodiments, other configurations and numbers of pipes 101 and other devices such as a cross-flow heat exchanger for transferring heat may also be used. The circulating device 12 of FIG. 3 comprises a fan 12, however other ventilation mechanisms may also be used. The housing 11 can store both the heat sink 10 and the fan 12, securing them in place through screw holes 113, although it is well-known that other means for securing the components, such as by configuring the housing 11 so that it can snap in place over the heat sink 10 and fan 12, may also be used. In some embodiments, no housing is required.

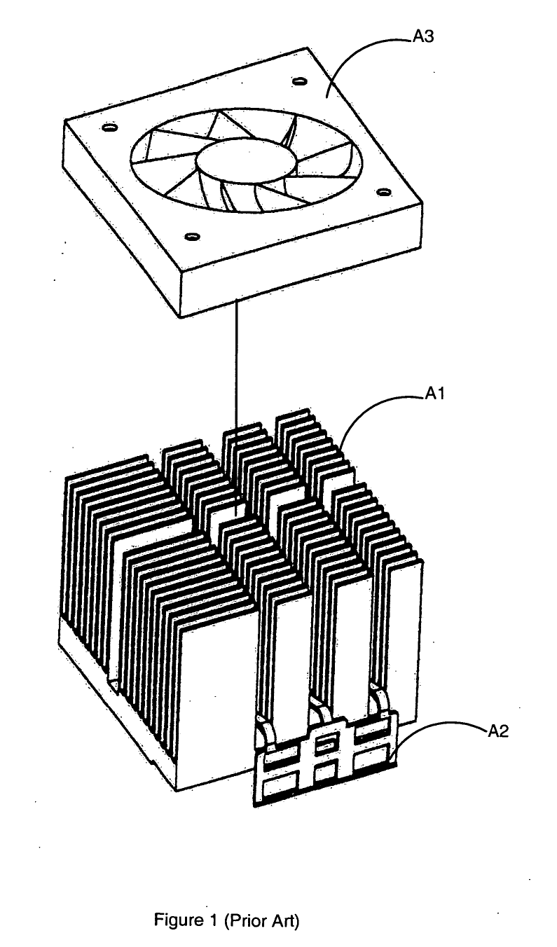

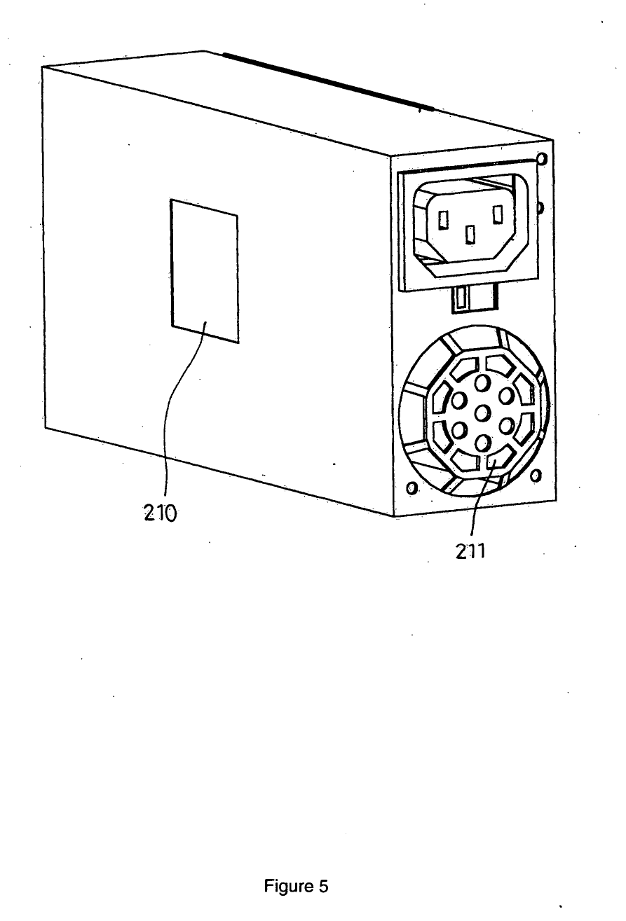

The housing 11, with CPU cooler 1 and fan 12 installed, can be mounted within the chassis of a computer 2 as shown. Portions of the CPU cooler 1 may be installed within a window 210 on the chassis 2; alternatively, the CPU cooler 1 could be installed adjacent to the window 210 or in another location. In an embodiment, a conductive screen (not shown) mounted on or formed into the chassis 2 covers the chassis window 210. The chassis 2 includes a power supply 21, which may or may not require a separate cooling fan, stored within. In one embodiment, the power supply 21 is configured within the chassis 2 such that the airflow directed by the fan 12, when installed in the chassis 2, passes directly over the power supply. Another view of the chassis 2 of FIG. 1, empty of any components, is provided by FIG. 5. In certain embodiments, one or more of the two windows 210 and 211 in the chassis 2 shown may be covered by filters or other means for blocking the intake or output of dust. In other embodiments, one or more of the windows 210 and 211 may be missing, or may be placed on alternative surfaces of the chassis 2.

The computer cooling apparatus of FIG. 3 can cool the CPU and chassis interior in several ways. In one embodiment, air is drawn in though the window 210 in the chassis 2, and carries the heat of the heat sink 10 away from the CPU and towards the fan 12. The fan 12 then directs the airflow towards the power supply 21, before being exhausted through the second window 211 or other opening in the chassis. In another embodiment, the airflow may be reversed depending on the direction of the fan's 12 rotation; in an embodiment, the rotation can be reversed by a user or responsive to the varying heat loads produced by the CPU and the power supply. In another embodiment, the heat pipe assemblies described in U.S. patent application Ser. No. 10/609,059, filed Jun. 27, 2003, entitled “CPU Cooling Using a Heat Pipe Assembly,” may be used.

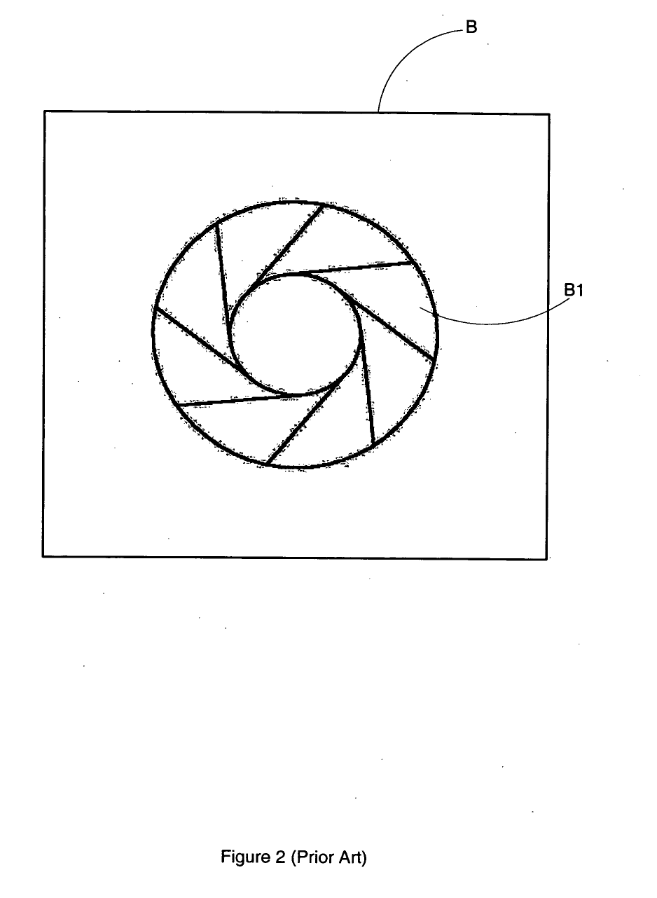

The orientation of the CPU cooler 1 with respect to the power supply 21 may also vary. In an embodiment, the power supply 21 is installed adjacent to the side of the chassis 2 opposite the chassis window 210. The CPU cooler 1 is installed in the orientation shown, so that the fan 12 blows air directly onto the power supply 21. In another embodiment, the power supply 21 is installed near the back of the computer in the bottom half of the chassis. The CPU cooler 1 is rotated and aligned from the position shown in FIG. 3 so that fan is facing the power supply 21. In an embodiment, there is a third window on the back of the computer so that airflow can be directed to or from the second window 211, across the length of the chassis 2 by the fan 12, simultaneously cooling the CPU and power supply. In either of these embodiments, the fan blows air directly on the power supply. In an embodiment, the apparatus of FIG. 2 may flexibly be adjusted to maximize cooling of the computer chassis. In addition, the airflow directed by the fan 12 can be leveraged to cool both the power supply 21 and the CPU, thus eliminating the need for a noisy second fan.

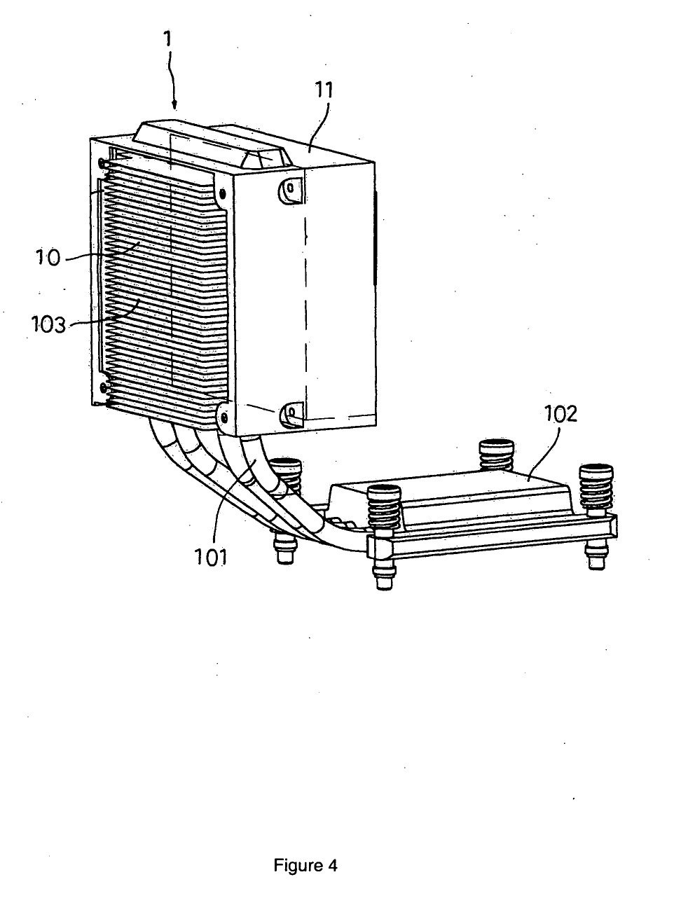

FIG. 4 is a perspective view of a CPU cooler 1 in accordance with an embodiment of the invention with which the heat transfer mechanism between a base plate 102 and heat sink 103 can be described in greater detail. The CPU cooler 1 comprises a base plate 102, heat conductor 101, heat sink 103, and housing 11. In the embodiment of the invention of FIG. 4, the heat sink 103 includes an even number of cooling fins 10, which could be composed of copper, aluminum, or other heat conductive material. Heat from a CPU (not shown) is transferred to the cooling fins 10 by way of four heat pipes 101. In an embodiment, each heat pipe 101 features a mesh grid (not shown) therein to conduct heat. In an embodiment, each heat pipe 101 can alternatively or in addition also contains water or another liquid with a high evaporation point (not shown).

In an embodiment, water in the heat pipe 101 is heated, causing the water to change into steam and rise. This rising hot water vapor brings heat to the heat sink 103. In an embodiment, a heat pipe 101 includes a metal weave interior to accelerate the heat transfer. Heat from the heat sink 103 is transferred to the air surrounding it, and this hot air is blown out of a computer chassis by a fan. As the water vapor in the heat pipe 101 near the heat sink 103 condenses into water, losing heat energy, the water vapor flows back into the heat pipe 101 and is available for to be heated again. In this process, heat generated by the CPU is removed from the housing of the personal computer.

The number of heat pipe 101 is selected according to the heat dissipation requirements of the system. Generally speaking, a heat pipe 21 in accordance with an embodiment of the present invention can absorb heat at a rate of about 30 to 40 Watts. High performance processors alone can generate up to 100 Watts, thus making it preferable to use at least three to four heat pipes.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. It is therefore intended that the scope of the invention be limited not by this detailed description, but rather by the claims appended hereto.

I claim:

1. A cooling apparatus for a computer comprising:
a conductive base plate configured to be installed over a CPU and to transfer heat therefrom;
a heat conductor thermally coupled to the base plate adapted to carry heat transferred to the base plate by the CPU away from the base plate;
a heat sink thermally coupled to the heat conductor for dissipating heat carried by the heat conductor;
a fan for dispersing heat transferred to the heat sink; and
a housing for the heat sink and the fan configured to be installed adjacent to a window in a computer chassis such that the fan can direct airflow through the heat sink and out the window.

2. The apparatus of claim 1, wherein the computer chassis is for a small form factor computer.

3. The apparatus of claim 1, wherein the heat conductor comprises one or more heat pipes.

4. The apparatus of claim 3, wherein the thermal conductor comprises a plurality of heat pipes, each heat pipe connected to the heat sink through a hole to facilitate heat exchange therebetween.

5. The apparatus of claim 3, wherein the heat pipes contain at least one of: a metal mesh grid and a liquid for transferring the heat contained within the heat pipe.

6. The apparatus of claim 1, wherein airflow is drawn over a power supply installed within the computer chassis, removing heat therefrom.

7. The apparatus of claim 1, wherein the fan is configured to face the power supply.

8. The apparatus of claim 1, wherein the heat sink comprises a conductive grill.

9. The apparatus of claim 8, wherein the conductive grill is made of one of: copper and compression molded aluminum.

10. The apparatus of claim 1, further comprising a computer chassis comprising the window in the computer chassis, a screen over the window, and a second window configured to intake ambient air.

11. A method of cooling the interior of a computer chassis, the method comprising:
transferring heat generated by a first component in the computer chassis to a heat sink through a base member installed adjacent to the first component and a cooling pipe connected to the heat sink; and
drawing ambient airflow into the chassis through a first window in the chassis, wherein the air flow is directed to pass over a second component in the chassis, pass through a fan, and be blown by the fan over the heat sink to outside the chassis.

12. A cooling apparatus for a computer comprising:
a circulation device adapted to fit between a heat sink to which heat from a computer CPU can be transferred and a power supply for the computer, wherein the circulation device is configured to be installed adjacent and parallel to both the heat sink and the power supply, and to direct heat away from the heat sink and power supply out through a window in a computer chassis.
